(19) United States
(12) Patent Application Publication
(10) Pub. No.: US 2026/0360112 A1
(43) Pub. Date: Nov. 12, 2026

(54) METHOD AND SYSTEM FOR LOW-COST MATERIAL CLASSIFICATION AND VOLUME ESTIMATION

(71) Applicant: Caterpillar Inc., Peoria, IL (US)

(72) Inventors: Lawrence A. Mianzo, Pittsburgh, PA (US); Tod A. Oblak, Pittsburgh, PA (US); Michael A. Spielman, Osseo, MI (US); Shaun D. Currier, Naperville, IL (US); Anthony D. McNealy, Dunlap, IL (US); Michael Hoffelder, Norwich, NY (US)

(73) Assignee: Caterpillar Inc., Peoria, IL (US)

(21) Appl. No.: 19/201,568

(22) Filed: May 7, 2025

(51) Int. Cl. G06V 10/764; G06T 7/62; G06T 7/73; G06V 10/26; G06V 10/75; G06V 10/762; G06V 10/77; G06V 10/774; G06V 10/778

(52) U.S. Cl. CPC G06V 10/764; G06T 7/62; G06T 7/74; G06V 10/26; G06V 10/751; G06V 10/7715; G06V 10/774; G06V 10/778; G06T 2207/10012; G06T 2207/10064; G06T 2207/10116; G06T 2207/20081; G06T 2207/20084; G06T 2207/30244; G06V 10/762

(57) ABSTRACT

A method for material classification and volume estimation of a material pile includes capturing training image frames of a training material pile and generating a training three dimensional (3D) geometric model; generating a camera-based training material classification based on the training image frames and the training 3D geometric model; generating first material classification data and a first material classification by using a reference classifier; generating supervisory data based on the first material classification data and the first material classification; generating second material classification data using a classifier having lower material analysis capabilities than the reference classifier; determining an initial material classification, from the second material classification data and the training 3D geometric model, based on the supervisory data, and generating a finalized training material classification and a finalized training 3D geometric model based on the initial material classification, the camera-based training material classification, and the training 3D geometric model.

### TECHNICAL FIELD

The present disclosure relates to a method and system for a material and volume analysis tool, and more specifically to a method and system for training, by a first analysis tool, a second analysis tool to enable the second analysis tool to perform specific tasks at a level similar to that of the first analysis tool where the first analysis tool is generally more capable than the second analysis tool.

### BACKGROUND

Currently material classification and tracking of material volume are often performed manually, which is tedious, labor intensive, and prone to errors. Because of the variability of material color, texture, aggregate size as well as material pile shape and size, finding appropriate visual features and labeling the required amount of training data can be particularly challenging. To automate and improve material classification and volume estimation of individual materials, sensors, such as high-end hyperspectral sensors, and/or sensing techniques, such as X-ray fluorescence (XRF) and Laser Induced Breakdown Spectroscopy (LIBS) may be included in a sensing device, however, such additional resources add cost and complexity to vehicles equipped with the sensing devices.

One system for identifying material type visual data with a teacher-student model is described in U.S. Patent Application Publication No. 2023/0196132 (“the '132 publication”). The '132 publication describes object material type identification using multiple types of sensors by obtaining a machine learning model that has been trained using training data comprising vision sensor data on a set of objects associated with material characteristic labels that are determined based at least in part on non-vision sensor data on the set of objects; obtaining a vision sensor signal corresponding to an object; and using the machine learning model and the vision sensor signal to determine a material characteristic type associated with the object.

While useful in creating a teacher model and student model, the '132 publication requires use of a hyperspectral sensor of the teacher model in real-time to train the student model, and visual data are fixed and not manipulable.

Examples of the present disclosure are directed to overcoming deficiencies of such systems.

### SUMMARY

In an aspect of the present disclosure, a method for training a student system with a teacher system to enable the student system to operate as a standalone material classifier is provided. The method includes capturing training image frames of a training material pile with a stereo camera system; based on the training image frames, generating a training three dimensional (3D) geometric model of the training material pile; generating a camera-based training material classification based on the training image frames and the training 3D geometric model; generating first material classification data associated with the training material pile and a first material classification of the training material pile, at least in part, by using a reference material classifier; generating supervisory data based at least in part on the first material classification data and the first material classification; generating second material classification data associated with the training material pile by using a target material classifier, the target material classifier having lower material analysis capabilities than the reference material classifier; determining an initial material classification of the training material pile, from the second material classification data and the training 3D geometric model, based at least in part on the supervisory data, the initial material classification matching the first material classification; and generating a finalized training material classification and a finalized training 3D geometric model of the training material pile based on the initial material classification, the camera-based training material classification, and the training 3D geometric model.

In another aspect of the present disclosure, a material classifier system is provided. The material classifier system includes one or more processors; a stereo camera system, including a first camera and a second camera, coupled to the one or more processors; a target material classifier coupled to the one or more processors; and memory coupled to the one or more processors storing computer-executable instructions that, when executed by the one or more processors, cause the one or more processors to perform operations. The operations include capturing, by the stereo camera system, training image frames of a training material pile; based on the training image frames, generating a training three dimensional (3D) geometric model of the training material pile; generating a camera-based training material classification based on the training image frames and the training 3D geometric model; receiving supervisory data generated based at least in part on first material classification data of the training material pile and a first material classification of the training material pile generated by a reference material classifier, the reference material classifier having higher material analysis capabilities than the target material classifier; generating, by the target material classifier, second material classification data associated with the training material pile; determining an initial material classification of the training material pile, from the second material classification data and the training 3D geometric model, based at least in part on the supervisory data, the initial material classification matching the first material classification; generating a finalized training material classification and a finalized training 3D geometric model of the training material pile based on the initial material classification, the camera-based training material classification, and the training 3D geometric model; capturing, by the stereo camera system, target image frames of a target material pile; generating a target 3D geometric model of the target material pile based on the target image frames; generating a camera-based target material classification based on the target image frames and the target 3D geometric model; generating target material classification data associated with the target material pile by using the target material classifier; determining a target material classification of the target material pile, from the target material classification data and the target 3D geometric model, based at least in part on the supervisory data; generating a finalized target material classification and a finalized target 3D geometric model of the target material based on the target material classification, the camera-based target material classification, and the target 3D geometric model, the finalized target 3D geometric model including a volume estimation of a material in the target material pile.

In yet another aspect of the present disclosure, non-transitory computer-readable storage media for operating a student system trained with a teacher system is provided. The non-transitory computer-readable storage media stores computer-readable instructions that, when executed by one or more processors, cause the one or more processors to perform operations. The operations include capturing training image frames of a training material pile with a stereo camera system; based on the training image frames, generating a training three dimensional (3D) geometric model of the training material pile; generating a camera-based training material classification based on the training image frames and the training 3D geometric model; generating first material classification data associated with the training material pile and a first material classification of the training material pile, at least in part, by using a reference material classifier; generating supervisory data based at least in part on the first material classification data and the first material classification; generating second material classification data associated with the training material pile by using a target material classifier, the target material classifier having lower material analysis capabilities than the reference material classifier; determining an initial material classification of the training material pile, from the second material classification data and the training 3D geometric model, based at least in part on the supervisory data, the initial material classification matching the first material classification; generating a finalized training material classification and a finalized training 3D geometric model of the training material pile based on the initial material classification, the camera-based training material classification, and the training 3D geometric model; capturing target image frames of a target material pile with the stereo camera system; generating a target 3D geometric model of the target material pile based on the target image frames; generating a camera-based target material classification based on the target image frames and the target 3D geometric model; generating target material classification data associated with the target material pile by using the target material classifier; determining a target material classification of the target material pile, from the target material classification data and the target 3D geometric model, based at least in part on the supervisory data; generating a finalized target material classification and a finalized target 3D geometric model of the target material based on the target material classification, the camera-based target material classification, and the target 3D geometric model.

### BRIEF DESCRIPTION OF DRAWINGS

The detailed description references the accompanying figures. In the figures, the left-most digit of a reference number identifies the figure in which the reference number first appears. The same reference numbers indicate similar or identical items.

FIG. 1 illustrates a schematic diagram depicting an example work site including a reference material classifier of a teacher system and a target material classifier of a student system.

FIG. 2 is a flow chart illustrating an example process of training a student system with a teacher system to enable the student system to operate as a standalone material classifier.

FIG. 3 is a flow chart detailing an example sub-process of one of the blocks of FIG. 2.

FIG. 4 is a flow chart detailing an example sub-process of another block of the blocks of FIG. 2

FIG. 5 is a flow chart illustrating an example process of operating the student system for material classification.

FIG. 6 is a block diagram of an example system for training the student system with the teacher system to enable the student system to operate as a standalone material classifier.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

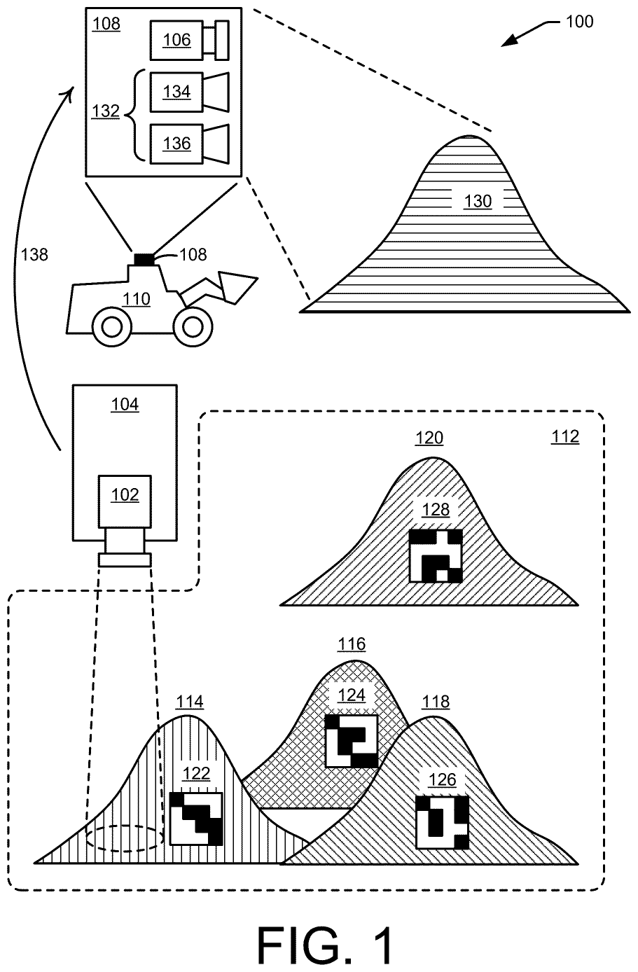

FIG. 1 illustrates a schematic diagram depicting an example work site 100 including a reference material classifier 102 of a teacher system 104 and a target material classifier 106 of a student system 108 shown as mounted on a work machine 110. The target material classifier 106 may have lower material analysis capabilities than the reference material classifier 102 in terms of sensors, computing, and infrastructure, and may be less expensive to purchase and operate. The reference material classifier 102 may be referred to as a high performance material classifier, and the target material classifier may be referred to as a low performance material classifier. In this example, a plurality of material piles 112 is illustrated with, but not limited to, four material piles 114, 116, 118, and 120, which may also be referred to as training material piles 114, 116, 118, and 120. The plurality of material piles 112 may have been previously analyzed and classified with material contents and locations. Each of the four material piles 114, 116, 118, and 120, may be tagged with corresponding fiducial markers, 122, 124, 126, and 128, that encode information, such as material and location information of the corresponding material piles. For example, the reference material classifier 102 may analyze the training material pile 114 and generate first material classification data for training the student system 108 based on the analysis of the training material pile 114 and the encoded information from the fiducial marker 122. During the training process, the student system 108 may generate a material classification of the training material pile 114 based on: analysis performed by the target material classifier 106 of the training material pile 114, images of the training material pile 114 captured by a stereo camera system 132 with a first camera 134 and a second camera 136, and the first material classification data provided by the teacher system 104 as shown by arrow 138. By utilizing the stereo camera system 132, instead of a single camera system, to capture the images of the training material pile 114, depth estimation associated with the training material pile 114 may also be realized. The first camera 134 and the second camera 136 may be RGB visible cameras. Once trained, the student system 108 may generate a material classification of a target material pile 130 based on images of the target material pile 130 captured by the stereo camera system 132 and material analysis of the target material pile 130 by the target material classifier 106.

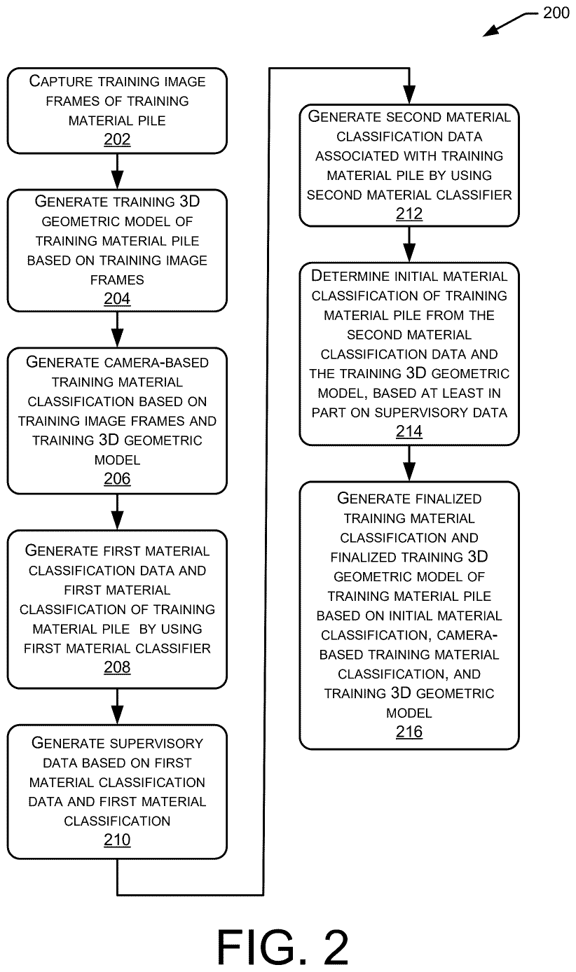

FIG. 2 is a flow chart illustrating an example process 200 of training a student system, such as the student system 108 with a teacher system, such as the teacher system 104 to enable the student system 108 to operate as a standalone material classifier. At block 202, training image frames of a training material pile, such as the training material pile 114, may be captured with a stereo camera system, such as the stereo camera system 132 enabling depth estimation of the training material pile 114, as described above with reference to FIG. 1. The training image frames may include timestamps. To obtain better or different view of the training material pile 114, the stereo camera system 132 may capture a first set of training image frames of the training material pile 114 in a first training position, manipulate the training material pile 114 into a second training position, and capture a second set of training image frames of the training material pile 114 in the second training position. Based on the training image frames, a training three dimensional (3D) geometric model of the training material pile 114 may be generated at block 204, and a camera-based training material classification may be generated based on the training image frames and the training 3D geometric model at block 206. For example, by performing hierarchical instance segmentation on the training image frames, the training image frames may be semantically segmented, the training material pile 114 may be distinguished from non-material-pile objects, and the camera-based training material classification may be generated based on the hierarchical instance segmentation.

At block 208, first material classification data associated with the training material pile 114 and a first material classification of the training material pile 114 may generated, at least in part, by using the reference material classifier 102. The reference material classifier 102 may be at least one of a first surface reflectance hyperspectral analyzer, an X-ray fluorescence analyzer, or a laser induced breakdown spectral analyzer. At block 210, supervisory data may be generated based, at least in part, on the first material classification data and first material classification.

At block 212, second material classification data associated with the training material pile 114 may be generated by using the target material classifier 106, which may be a second surface reflectance hyperspectral analyzer. As discussed above with referenced to FIG. 1, the target material classifier 106 may have lower material analysis capabilities than the reference material classifier 102 in terms of sensors, computing, and infrastructure. At block 214, an initial material classification of the training material pile 114 may be determined from the second material classification data and the training 3D geometric model, based at least in part on the supervisory data with a condition that the initial material classification matches the first material classification with a predetermined tolerance, for example, but not limited to, within 5% of material composition of the training material pile 114 associated with the first material classification. For example, the supervisory data may be transferred from the teacher system 104 to the student system 108 to be used by the student system 108 for analysis of material piles, such as the training material pile 114 and the target material pile 130. At block 216 a finalized training material classification and a finalized training 3D geometric model of the training material pile may be generated based on the initial material classification, the camera-based training material classification, and the training 3D geometric model. The finalized training material classification and the finalized training 3D geometric model may include generating a volume estimation of a material in the training material pile 114 and a volume removed from the training material pile 114. The training of the student system 108 with the teacher system 104 may then be completed, and the student system 108 may now be operated, without the teacher system 104, for classifying a material pile, such as the target material pile 130.

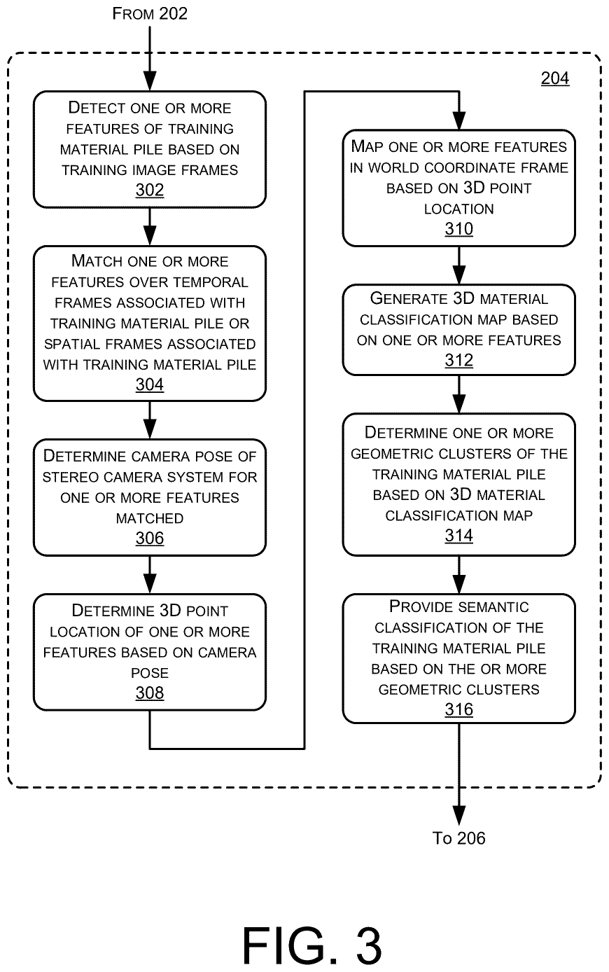

FIG. 3 is a flow chart detailing an example sub-process of block 204 of FIG. 2 for generating the training 3D geometric model of the training material pile of the training material pile. At block 302, one or more features of the training material pile 114 may be detected based on the training image frames, and the one or more features may be matched over temporal frames associated with the training material pile 114 or spatial frames associated with the training material pile 114 at block 304. A camera pose of the stereo camera system 132 for the one or more features matched may be determined at block 306 and a 3D point location of the one or more features may be determined based on the camera pose at block 308. The one or more features may include, but are not limited to, colors and textures of materials in the training material pile 114, aggregate size of the training material pile 114, and shapes and sizes of the training material pile 114. At block 310, the one or more features may be mapped in a world coordinate frame based on the 3D point location, and a 3D material classification map may be generated based on the one or more features at block 312. At block 314, one or more geometric clusters of the training material pile may be determined based on the 3D material classification map, and semantic classification of the training material pile may be provided based on the one or more geometric clusters at block 316.

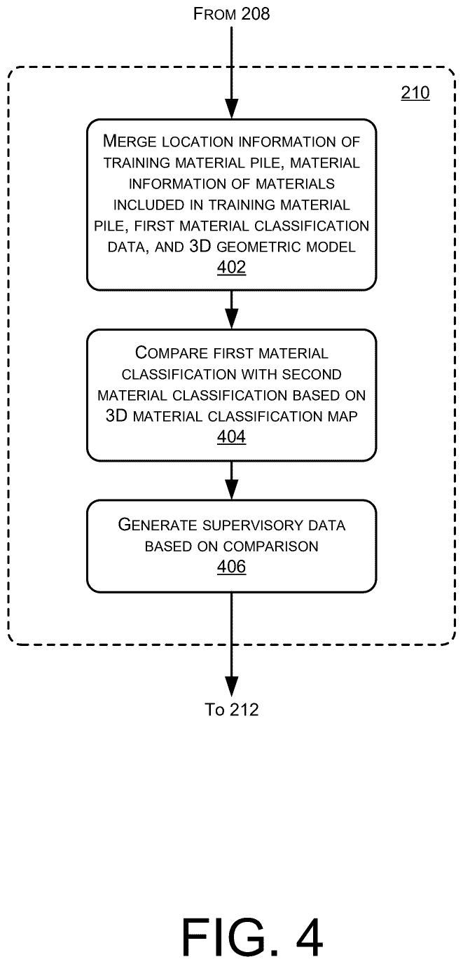

FIG. 4 is a flow chart detailing an example sub-process of block 210 of FIG. 2 for generating the supervisory data. At block 402, location information of the training material pile 114, material information of materials included in the training material pile 114, the first material classification data, and the 3D geometric model may be merged. At block 404, the first material classification may be compared with the second material classification based on the 3D material classification map, and the supervisory data may be generated based on the comparison at block 406. As discussed above with reference to FIG. 1, the training material pile 114 may include a fiducial marker, such as the fiducial marker 122, which encodes the location information of the training material pile 114 or both the location information of the training material pile 114 and the material information of the training material pile 114.

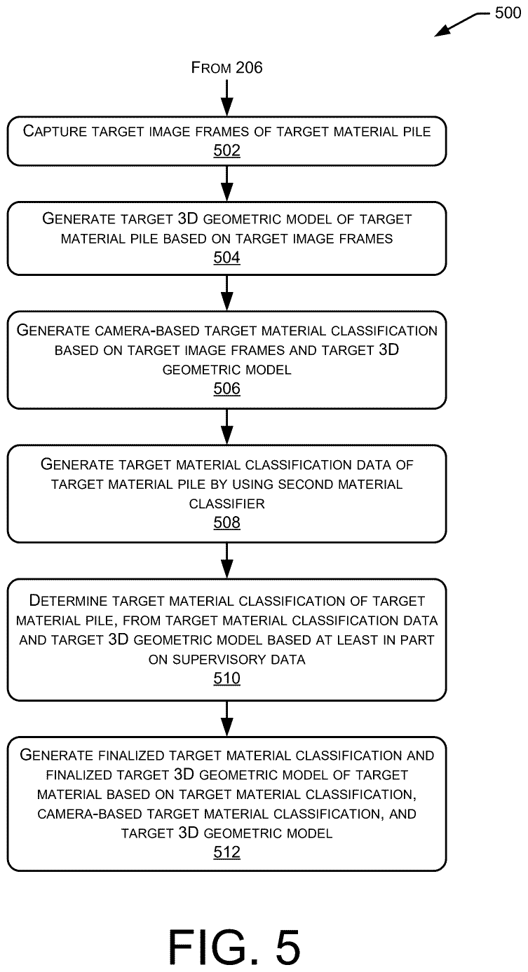

FIG. 5 is a flow chart illustrating an example process 500 of operating the student system 108 for material classification, which may follow the process 200 of training the student system 108 as described above with reference to FIGS. 2-4. At block 502, target image frames of a target material pile, such as the target material pile 130, may be captured with the stereo camera system 132, as described above with reference to FIG. 1. The target image frames may include timestamps. To obtain better or different views of the target material pile 130, the stereo camera system 132 may capture a first set of target image frames of the target material pile 130 in a first target position, manipulate the target material pile 130 into a second target position, and capture a second set of target image frames of the target material pile 130 in the second target position. Based on the target image frames, a target 3D geometric model of the target material pile 130 may be generated at block 504, and a camera-based target material classification may be generated based on the target image frames and the target 3D geometric model at block 506. For example, by performing hierarchical instance segmentation on the target image frames, the target image frames may be semantically segmented, the target material pile 130 may be distinguished from non-material-pile objects, and the camera-based target material classification may be generated based on the hierarchical instance segmentation.

At block 508, target material classification data associated with the target material pile 130 may be generated by using the target material classifier 106, and a target material classification of the target material pile 130, from the target material classification data and the target 3D geometric model, may be determined based at least in part on the supervisory data at block 510. At block 512, a finalized target material classification and a finalized target 3D geometric model of the target material may be generated based on the target material classification, the camera-based target material classification, and the target 3D geometric model. The finalized target material classification and the finalized target 3D geometric model may include generating a volume estimation of a material in the target material pile 130 and a volume removed from the target material pile 130.

The processes described above with reference to FIGS. 2-5 may be performed by implementing machine learning. For example, the teacher system 104 and/or the student system 108 may be configured to implement pattern/sequence recognition into a real-time decision loop that, e.g., is enabled by machine learning. The types of machine learning implemented by the teacher system 104 and/or the student system 108 may include various approaches to learning and pattern recognition. The machine learning may include the implementation of associative memory, which allows storage, discovery, and retrieval of learned associations between extremely large numbers of attributes in real time. At a basic level, an associative memory stores information about how attributes and their respective features occur together. The predictive power of the associative memory technology comes from its ability to interpret and analyze these co-occurrences and to produce various metrics. Associative memory is built through “experiential” learning in which each newly observed state is accumulated in the associative memory as a basis for interpreting future events. Thus, by observing normal system operation over time, and the normal predicted system operation over time, the associative memory is able to learn normal patterns as a basis for identifying non-normal behavior and appropriate responses, and to associate patterns with particular outcomes, contexts or responses.

The teacher system 104 and/or the student system 108 may utilize a machine learning engine that includes a corresponding receiving module configured to receive training data from a plurality of sources described above, such as the reference material classifier 102, the target material classifier 106, and the stereo camera system 132. The training data may include real-time configuration and operational data, and may be communicated to the receiving module and to the machine learning engine over wireless and/or wired networks. The training data may include historical operational data acquired by the receiving module such as data from the plurality of sources. The training data may also include data from a plurality of devices similar to the teacher system 104 and the student system 108. First input conditions, such as the training image frames, can represent conditions which, when applied to the student system 108, lead to a particular response being performed, such as generating a 3D material classification map.

The machine learning engine may be configured to train a learning system using the training data to generate a second responses based on a second input condition. The machine learning engine can provide the training data as an input to the learning system, monitor an output of the learning system, and modify the learning system based on the output. The machine learning engine can compare the output to the plurality of first responses, determine a difference between the output and the plurality of first responses, and modify the learning system based on the difference between the output and the plurality of first responses. For example, the machine learning engine can be configured to modify characteristics of the learning system to optimize the supervisory data for classifying the target material pile 130 with the target material classifier 106. The machine learning engine can group the training data into a first set of training data for executing a first learning protocol, and a second set of training data for executing a second learning protocol.

The learning system can include a learning function configured to associate the plurality of input conditions to the plurality of first responses, and the learning function can define characteristics, such as a plurality of parameters. The machine learning engine can be configured to modify the plurality of parameters to decrease the difference between the output of the learning system (e.g., the output of the learning function) and the plurality of first responses. Once trained, the learning system can be configured to receive the second input condition and apply the learning function to the second input condition to generate the second responses. In some embodiments, the learning system may include a neural network. The neural network can include a plurality of layers each including one or more nodes, such as a first layer (e.g., an input layer), a second layer (e.g., an output layer), and one or more hidden layers. The neural network can include characteristics such weights and biases associated with computations that can be performed between nodes of layers. The machine learning engine can be configured to train the neural network by providing the first input conditions to the first layer of the neural network. The neural network can generate a plurality of first outputs based on the first input conditions, such as by executing computations between nodes of the layers. The machine learning engine can receive the plurality of first outputs, and modify a characteristic of the neural network to reduce a difference between the plurality of first outputs and the plurality of first responses.

In some embodiments, the learning system may include a classification engine, such as a support vector machine (SVM). The SVM can be configured to generate a mapping of first input conditions to first responses. For example, the machine learning engine may be configured to train the SVM to generate one or more rules configured to classify training pairs (e.g., each first input condition and its corresponding first response). The classification of training pairs can enable the mapping of first input conditions to first response by classifying particular first response as corresponding to particular first input conditions. Once trained, the learning system can generate the second response maneuver based on the second input condition by applying the mapping or classification to the second input condition.

In some embodiments, the learning system may include a Markov decision process engine. The machine learning engine may be configured to train the Markov decision process engine to determine a policy based on the training data, the policy indicating, representing, or resembling how a particular material pile would be classified by an experienced human engineer/inspector in response to various input conditions. The machine learning engine can provide the first input conditions to the Markov decision process engine as a set or plurality of states (e.g., a set or plurality of finite states). The machine learning engine can provide the first responses to the Markov decision process as a set or plurality of actions (e.g., a set or plurality of finite actions). The machine learning engine can execute the Markov decision process engine to determine the policy that best represents the relationship between the first input conditions and first responses. It will be appreciated that in various embodiments, the learning system can include various other machine learning engines and algorithms, as well as combinations of machine learning engines and algorithms, that can be executed to determine a relationship between the plurality of first input conditions and the plurality of first responses and thus train the learning system.

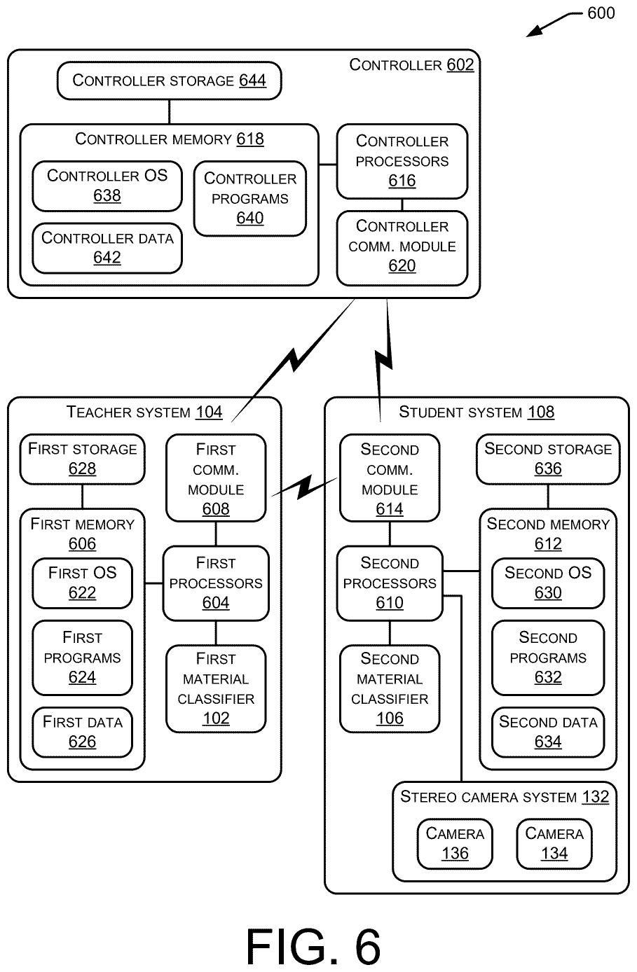

FIG. 6 is a block diagram of an example system 600 comprising the teacher system 104, the student system 108, and a controller 602 for operating the teacher system 104 to train the student system 108 to enable the student system to operate as a standalone material classifier, as described above with reference to FIGS. 1-4. Alternatively, the student system 108 may pair with the teacher system 104 without the controller 602 during training process. Once trained, the student system 108 may operate as a standalone material classifier as described above with reference to FIG. 5. In various embodiments, the teacher system 104 may include first one or more processors (first processors) 604, first memory 606 coupled to the first processors 604, a first communication module 608 coupled to the first processors 604, and the reference material classifier 102 coupled to the first processors 604. The student system 108 may include second one or more processors (second processors) 610, second memory 612 coupled to the second processors 610, a second communication module 614 coupled to the second processors 610, the target material classifier 106 coupled to the second processors 610, and the stereo camera system 132 including the first camera 134 and the second camera 136 coupled to the second processors 610. The controller 602 may include one or more controller processors (controller processors) 616, controller memory 618 coupled to the controller processors 616, and a controller communication module 620 coupled to the controller processors 616. The student system 108 may be mounted to a work machine, such as the work machine 110, with an implement designed to scoop, move, and/or dig into a material pile, which may be utilized to manipulate material of the material pile, for example, to better capture image frames of the material pile as described above with reference to FIGS. 1 and 2.

Each, or any, of the first processors 604, the second processors 610, and the controller processors 616, can be a central processing unit (CPU), a graphics processing unit (GPU), or both CPU and GPU, or any other type of processing unit. The first processors 604 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The first processors 604 may also be responsible for executing all computer applications stored in the first memory 606, the second processors 610 may also be responsible for executing all computer applications stored in the second memory 612, and the controller processors 616 may also be responsible for executing all computer applications stored in the controller memory 618.

Depending on the exact configurations and types of the teacher system 104, the student system 108, and the controller 602, each, or any, of the first memory 606, the second memory 612, and the controller memory 618, may be volatile (such as RAM), non-volatile (such as ROM, flash memory, etc.) or some combination of both. The first memory 606 may include, or store, a first operating system (OS) 622, one or more first program modules 624, and may include first program data 626. The teacher system 104 may also include additional data storage devices (removable and/or non-removable) such as, for example, a flash drive, an SD card, magnetic disks, optical disks, or tape, illustrated in FIG. 6 as a first storage 628. The second memory 612 may include, or store, a second OS 630, one or more second program modules 632, and may include second program data 634. The student system 108 may also include additional data storage devices illustrated as a second storage 636. The controller memory 618 may include, or store, a controller OS 638, one or more controller program modules 640, and may include controller program data 642. The controller 602 may also include additional data storage devices illustrated as a controller storage 644.

Non-transitory computer-readable storage media of the system 600, such as the first memory 606, the first storage 628, the second memory 612, the second storage 636, the controller memory 618, and the controller storage 644, may include volatile and nonvolatile, removable and non-removable media implemented in any method or technology for storage of information, such as computer-readable, or computer-executable, instructions, data structures, program modules, or other data. The first memory 606, the first storage 628, the second memory 612, the second storage 636, the controller memory 618, and the controller storage 644 are all examples of computer-readable storage media. Non-transitory computer-readable storage media includes, but is not limited to, phase change memory (PRAM), static random-access memory (SRAM), dynamic random-access memory (DRAM), RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store the desired information and which can be accessed by the associated processors, such as the first processors 604, the second processors 610, or the controller processors 616. In contrast, communication media may embody computer-readable, or computer-executable, instructions, data structures, program modules, or other data in a modulated data signal, such as a carrier wave, or other transmission mechanism. As defined herein, non-transitory computer-readable storage media do not include communication media.

The computer-readable instructions stored on one or more non-transitory computer-readable storage media, such as the first memory 606, the first storage 628, the second memory 612, the second storage 636, the controller memory 618, and the controller storage 644, when executed by the processor, such as the first processors 604, the second processors 610, and the controller processors 616, may cause the first processors 604, the second processors 610, and the controller processors 616 to perform operations described above with reference to FIGS. 1-5. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. For example, the controller program modules 640 may include the computer-readable instructions to control the teacher system 104 and the student system 108 during the training process as described above with reference to FIGS. 2-4, the first program modules 624 may include the computer-readable instructions to operate the teacher system 104 with instructions from the controller 602 during the training process as described above with reference to FIGS. 2-4, and the second program modules 632 may include the computer-readable instructions to operate the student system 108 with instructions from the controller 602 during the training process as described above with reference to FIGS. 2-4. Additionally, the second program modules 632 may include the computer-readable instructions to operate the student system 108 as a standalone material classifier for classifying material piles after the training process as described above with reference to FIG. 5.

Each of the first communication module 608, the second communication module 614, and the controller communication module 620, may include a long-range transceiver, a short-range transceiver, and/or a wired transceiver. The long-range transceivers may include one or more transceivers for communicating over cellular networks, such as 2G, 3G, 4G, 5G, and/or other cellular-wireless access technologies. The short-range transceivers may include one or more transceivers for communicating using short-range wireless communication schemes, such as Bluetooth, WiFi, ZigBee, NFC, and other communication methods. The short-range transceiver and the wired transceiver may also be used to receive and transmit the same or similar data, information, and instructions as the long-range transceiver. The first communication module 608, the second communication module 614, and the controller communication module 620 may be used to transmit and receive various information including instructions from the controller 602 to the teacher system 104 and the student system 108, data exchange between the teacher system 104 and the student system 108, such as the 3D geometric model, the 3D material map, the first material data, the second material data, the supervisory data, and other data as discussed above with reference to FIGS. 1-5.

### Industrial Applicability

Material classification and tracking of material volume and the material volume moved from a given site are often manually performed. To improve material classification and volume estimation, additional high-end material classifiers or sensors, such as high-end hyperspectral sensors or similar expensive sensors, may be added. However, this approach may add cost and complexity. The present disclosure provides methods and systems for training a student system, with a material classifier of lower analysis capabilities and lower cost than the high-end hyperspectral sensor, by a teacher system with the high-end material classifier of higher analysis capabilities than the student system to enable the student system to operate at the analysis capabilities similar to those of the teacher system for material classification and volume estimation.

A method for training a student system with a teacher system to enable the student system to operate as a standalone material classifier includes capturing training image frames of a training material pile with a stereo camera system; based on the training image frames, generating a training three dimensional (3D) geometric model of the training material pile the training material pile; generating a camera-based training material classification based on the training image frames and the training 3D geometric model; generating first material classification data associated with the training material pile and a first material classification of the training material pile, at least in part, by using a reference material classifier; generating supervisory data based at least in part on the first material classification data and the first material classification; generating second material classification data associated with the training material pile by using a target material classifier, the target material classifier having lower material analysis capabilities than the reference material classifier; determining an initial material classification of the training material pile, from the second material classification data and the training 3D geometric model, based at least in part on the supervisory data, the initial material classification matching the first material classification; and generating a finalized training material classification and a finalized training 3D geometric model of the training material pile based on the initial material classification, the camera-based training material classification, and the training 3D geometric model.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or “one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

While aspects of the present disclosure have been particularly shown and described with reference to the examples above, it will be understood by those skilled in the art that various additional embodiments may be contemplated by the modification of the disclosed devices, systems, and methods without departing from the spirit and scope of what is disclosed. Such embodiments should be understood to fall within the scope of the present disclosure as determined based upon the claims and any equivalents thereof.

What is claimed is:

1. A method comprising:
capturing training image frames of a training material pile with a stereo camera system;
based on the training image frames, generating a training three dimensional (3D) geometric model of the training material pile;
generating a camera-based training material classification based on the training image frames and the training 3D geometric model;
generating first material classification data associated with the training material pile and a first material classification of the training material pile, at least in part, by using a reference material classifier;
generating supervisory data based at least in part on the first material classification data and the first material classification;
generating second material classification data associated with the training material pile by using a target material classifier, the target material classifier having lower material analysis capabilities than the reference material classifier;
determining an initial material classification of the training material pile, from the second material classification data and the training 3D geometric model, based at least in part on the supervisory data, the initial material classification matching the first material classification; and
generating a finalized training material classification and a finalized training 3D geometric model of the training material pile based on the initial material classification, the camera-based training material classification, and the training 3D geometric model.

2. The method of claim 1, further comprising:
capturing target image frames of a target material pile with the stereo camera system;
generating a target 3D geometric model of the target material pile based on the target image frames;
generating a camera-based target material classification based on the target image frames and the target 3D geometric model;
generating target material classification data associated with the target material pile by using the target material classifier;
determining a target material classification of the target material pile, from the target material classification data and the target 3D geometric model, based at least in part on the supervisory data; and
generating a finalized target material classification and a finalized target 3D geometric model of the target material pile based on the target material classification, the camera-based target material classification, and the target 3D geometric model.

3. The method of claim 2, wherein the reference material classifier includes at least one of:
a first surface reflectance hyperspectral analyzer,
an X-ray fluorescence analyzer, or
a laser induced breakdown spectral analyzer.

4. The method of claim 3, wherein the target material classifier includes a second surface reflectance hyperspectral analyzer.

5. The method of claim 1, wherein generating the training 3D geometric model of the training material pile includes implementing machine learning to:
detect one or more features of the training material pile based on the training image frames;
match the one or more features over at least one of:
temporal frames associated with the training material pile, or
spatial frames associated with the training material pile;
determine a camera pose of the stereo camera system for the one or more features matched;
determine a 3D point location of the one or more features based on the camera pose;
map the one or more features in a world coordinate frame based on the 3D point location; and
generate a 3D material classification map based on the one or more features mapped.

6. The method of claim 5, wherein generating the training 3D geometric model of the training material pile further includes implementing machine learning to:
determine one or more geometric clusters of the training material pile based on the 3D material classification map; and
provide semantic classification of the training material pile based on the one or more geometric clusters.

7. The method of claim 5, wherein generating the supervisory data includes implementing machine learning to:
merge location information of the training material pile, material information of materials included in the training material pile, the first material classification data, and the training 3D geometric model;
compare the first material classification with the initial material classification based on the 3D material classification map; and
generate the supervisory data based on the comparing.

8. The method of claim 7, wherein the training material pile includes a fiducial marker encoding one of:
the location information of the training material pile, or
the location information of the training material pile and the material information of the training material pile.

9. The method of claim 2, wherein generating the camera-based training material classification based on the training image frames and the training 3D geometric model includes implementing machine learning to:
perform hierarchical instance segmentation to:
semantically segment the training image frames, and
distinguish the training material pile from non-material-pile objects; and
generate the camera-based training material classification based on the hierarchical instance segmentation.

10. The method of claim 2, wherein:
capturing the training image frames of the training material pile with the stereo camera system includes:
capturing a first set of training image frames of the training material pile in a first training position,
manipulating the training material pile into a second training position, and
capturing a second set of training image frames of the training material pile in the second training position; and
capturing the target image frames of the target material pile with the stereo camera system includes:
capturing a first set of target image frames of the target material pile in a first target position,
manipulating the target material pile into a second target position, and
capturing a second set of target image frames of the target material pile in the second target position.

11. The method of claim 2, wherein generating the finalized training material classification and the finalized training 3D geometric model includes generating a volume estimation of a material in the training material pile.

12. The method of claim 2, wherein generating the finalized target material classification and the finalized target 3D geometric model includes generating a volume estimation of a material in the target material pile.

13. A material classifier system comprising:
one or more processors;
a stereo camera system, including a first camera and a second camera, coupled to the one or more processors;
a target material classifier coupled to the one or more processors; and
memory coupled to the one or more processors storing computer-executable instructions that, when executed by the one or more processors, cause the one or more processors to perform operations, the operations comprising:
capturing, by the stereo camera system, training image frames of a training material pile;
based on the training image frames, generating a training three dimensional (3D) geometric model of the training material pile;
generating a camera-based training material classification based on the training image frames and the training 3D geometric model;
receiving supervisory data generated based at least in part on first material classification data of the training material pile and a first material classification of the training material pile generated by a reference material classifier, the reference material classifier having higher material analysis capabilities than the target material classifier;
generating, by the target material classifier, second material classification data associated with the training material pile;
determining an initial material classification of the training material pile, from the second material classification data and the training 3D geometric model, based at least in part on the supervisory data, the initial material classification matching the first material classification;
generating a finalized training material classification and a finalized training 3D geometric model of the training material pile based on the initial material classification, the camera-based training material classification, and the training 3D geometric model;
capturing, by the stereo camera system, target image frames of a target material pile;
generating a target 3D geometric model of the target material pile based on the target image frames;
generating a camera-based target material classification based on the target image frames and the target 3D geometric model;
generating target material classification data associated with the target material pile by using the target material classifier;
determining a target material classification of the target material pile, from the target material classification data and the target 3D geometric model, based at least in part on the supervisory data; and
generating a finalized target material classification and a finalized target 3D geometric model of the target material pile based on the target material classification, the camera-based target material classification, and the target 3D geometric model, the finalized target 3D geometric model including a volume estimation of a material in the target material pile.

14. The material classifier system of claim 13, wherein:
the reference material classifier includes at least one of:
a first surface reflectance hyperspectral analyzer,
an X-ray fluorescence analyzer, or
a laser induced breakdown spectral analyzer, and
the target material classifier includes a second surface reflectance hyperspectral analyzer.

15. The material classifier system of claim 13, wherein generating the training 3D geometric model of the training material pile includes implementing machine learning to:
detect one or more features of the training material pile based on the training image frames;
match the one or more features over at least one of:
temporal frames associated with the training material pile, or
spatial frames associated with the training material pile;
determine a camera pose of the stereo camera system for the one or more features matched;
determine a 3D point location of the one or more features based on the camera pose;
map the one or more features in a world coordinate frame based on the 3D point location;
generate a 3D material classification map based on the one or more features mapped;
determine one or more geometric clusters of the training material pile based on the 3D material classification map; and
provide semantic classification of the training material pile based on the one or more geometric clusters.

16. The material classifier system of claim 15, wherein generating the supervisory data includes implementing machine learning to:
merge location information of the training material pile, material information of materials included in the training material pile, the first material classification data, and the 3D training geometric model;
compare the first material classification with the initial material classification based on the 3D material classification map, and
generate the supervisory data based on the comparing.

17. The material classifier system of claim 13, wherein generating the camera-based training material classification based on the training image frames and the training 3D geometric model includes implementing machine learning to:
perform hierarchical instance segmentation to:
semantically segment the training image frames, and
distinguish the training material pile from non-material-pile objects; and
generate the camera-based training material classification based on the hierarchical instance segmentation.

18. Non-transitory computer-readable storage media storing computer-readable instructions that, when executed by one or more processors, cause the one or more processors to perform operations, the operations comprising:
capturing training image frames of a training material pile with a stereo camera system;
based on the training image frames, generating a training three dimensional (3D) geometric model of the training material pile;
generating a camera-based training material classification based on the training image frames and the training 3D geometric model;
generating first material classification data associated with the training material pile and a first material classification of the training material pile, at least in part, by using a reference material classifier;
generating supervisory data based at least in part on the first material classification data and the first material classification;
generating second material classification data associated with the training material pile by using a target material classifier, the target material classifier having lower material analysis capabilities than the reference material classifier;
determining an initial material classification of the training material pile, from the second material classification data and the training 3D geometric model, based at least in part on the supervisory data, the initial material classification matching the first material classification;
generating a finalized training material classification and a finalized training 3D geometric model of the training material pile based on the initial material classification, the camera-based training material classification, and the training 3D geometric model;
capturing target image frames of a target material pile with the stereo camera system;
generating a target 3D geometric model of the target material pile based on the target image frames;
generating a camera-based target material classification based on the target image frames and the target 3D geometric model;
generating target material classification data associated with the target material pile by using the target material classifier;
determining a target material classification of the target material pile, from the target material classification data and the target 3D geometric model, based at least in part on the supervisory data; and
generating a finalized target material classification and a finalized target 3D geometric model of the target material pile based on the target material classification, the camera-based target material classification, and the target 3D geometric model.

19. The non-transitory computer-readable storage media of claim 18, wherein generating the camera-based training material classification based on the training image frames and the training 3D geometric model includes implementing machine learning to:
perform hierarchical instance segmentation to:
semantically segment the training image frames, and
distinguish the training material pile from non-material-pile objects; and
generate the camera-based training material classification based on the hierarchical instance segmentation.

20. The non-transitory computer-readable storage media of claim 18, wherein:
generating the training 3D geometric model of the training material pile includes implementing machine learning to:
detect one or more features of the training material pile based on the training image frames,
match the one or more features over at least one of:
temporal frames associated with the training material pile, or
spatial frames associated with the training material pile;
determine a camera pose of the stereo camera system for the one or more features matched,
determine a 3D point location of the one or more features based on the camera pose,
map the one or more features in a world coordinate frame based on the 3D point location, and
generate a 3D material classification map based on the one or more features mapped; and
generating the supervisory data includes implementing machine learning to:
merge location information of the training material pile, material information of materials included in the training material pile, the first material classification data, and the training 3D geometric model,
compare the first material classification with the initial material classification based on the 3D material classification map, and
generate the supervisory data based on the comparing.
